(19) United States
(12) Patent Application Publication
(10) Pub. No.: US 2020/0068040 A1
(43) Pub. Date: Feb. 27, 2020

(54) SYSTEM AND METHOD FOR PROVIDING CONTENTS

(71) Applicants: HYUNDAI MOTOR COMPANY, Seoul (KR); KIA MOTORS CORPORATION, Seoul (KR)

(72) Inventor: Hyun Soo KIM, Hwaseong-Si (KR)

(21) Appl. No.: 16/178,044

(22) Filed: Nov. 1, 2018

(30) Foreign Application Priority Data
Aug. 21, 2018 (KR) 10-2018-0097484

(51) Int. Cl. H04L 29/08

(52) U.S. Cl. CPC H04L 67/306; G06F 3/0482; H04L 67/12

(57) ABSTRACT

A system for providing contents includes: at least one or more user terminals having first user information; a vehicle terminal configured to receive the first user information from the at least one or more user terminals and configured to collect and classify the first user information and pre-stored second user information; and a server configured to analyze the first and second user information collected and classified by the vehicle terminal. The vehicle terminal provides contents based on an analyzed result provided from the server.

### CROSS-REFERENCE TO RELATED APPLICATION

This application is claims the benefit of priority to Korean Patent Application No. 10-2018-0097484, filed in the Korean Intellectual Property Office on Aug. 21, 2018, the entire contents of which are incorporated herein by reference.

### TECHNICAL FIELD

The present disclosure relates to a system and a method for providing contents by using user information in multiple devices connected to a vehicle.

### BACKGROUND

A vehicle head unit (H/U) applied to a vehicle allows the connection of a single device and receives information from the single device to process the information. As such, a conventional vehicle H/U provides a service by using only the information of the single device.

Accordingly, a portable device of a specific user can be connected to the vehicle H/U and the service can be provided by using user information in the connected portable device, when a plurality of users are in a vehicle. Thus, the service may not be provided in consideration of preferences and interests of the plurality of users in the vehicle.

### SUMMARY

The present disclosure has been made to solve the above-mentioned problems occurring in the prior art while advantages achieved by the prior art are maintained intact.

An aspect of the present disclosure provides a system and a method for providing contents that provide contents optimized for the common interest of users by using user information in multiple devices connected to a vehicle.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a system for providing contents includes: at least one or more user terminals having first user information; a vehicle terminal receiving the first user information from the at least one or more user terminals and collecting and classifying the first user information and pre-stored second user information; and a server analyzing the first and second user information collected and classified by the vehicle terminal. The vehicle terminal provides contents based on an analyzed result provided from the server.

The vehicle terminal includes: a communication device performing wireless communication with at least one or more of the at least one or more user terminals and the server; an interface supporting wired communication with the at least one or more user terminals; and a processor sensing connections of the at least one or more user terminals through at least one or more of the communication device and the interface.

The communication device performs wireless communication by using at least one or more of wireless Internet, short range communication, and mobile communication.

The interface is implemented with a port for connecting the at least one or more user terminals to the vehicle terminal via a wired cable.

The at least one or more user terminals transmit the user information to the vehicle terminal through at least one or more of the communication device and the interface.

The processor collects and classifies the first user information and the second user information based on terminal identification information of the at least one or more user terminals and the vehicle terminal.

The server analyzes the user information collected and classified by the vehicle terminal to grasp common interest of users, and generates content information based on the grasped common interest of the users.

The server generates content information for each user in consideration of the user information collected and classified by the vehicle terminal and extracts data, which is duplicated more than a specified number of times in the generated content information for each user, to generate final content information.

The server generates content information for each terminal in consideration of the user information collected and classified by the vehicle terminal and extracts data, which is duplicated more than a specified number of times in the generated content information for each terminal, to generate final content information.

The vehicle terminal receives the content information from the server to display the content information.

Each of the first user information and second user information includes content usage information of a user.

According to another aspect of the present disclosure, a vehicle terminal includes: a communication device performing wireless communication with at least one or more user terminals and a server; a processor receiving first user information from the at least one or more user terminals; and a storage storing second user information. The processor collects and classifies the first user information and the second user information to transmit the collected and classified first and second user information to the server, and provides contents based on a result in which the server analyzes the collected and classified first and second user information.

According to still another aspect of the present disclosure, a method for providing contents includes: making, by a vehicle terminal, a connection to at least one or more user terminals; receiving, by the vehicle terminal, first user information from the connected at least one or more user terminals; collecting and classifying, by the vehicle terminal, the received first user information and pre-stored second user information to transmit the collected and classified first and second user information to a server; analyzing, by the server, the first and second user information collected and classified by the vehicle terminal to transmit an analyzed result to the vehicle terminal; and providing, by the vehicle terminal, contents based on the analyzed result.

In the making of the connection, the at least one or more user terminals are connected to the vehicle terminal over wireless communication or wired communication.

In the receiving of the first user information, the connected at least one or more user terminals transmit the first user information including identification information of the at least one or more user terminals, to the vehicle terminal.

In the collecting and classifying of the received first user information and the pre-stored second user information to transmit the collected and classified user information to the server, the vehicle terminal collects and classifies the first user information and the second user information stored in the vehicle terminal, based on identification information of the at least one or more user terminals and the vehicle terminal.

In the transmitting of the analyzed result to the vehicle terminal, the server analyzes the collected and classified user information to grasp common interest of users, and generates content information based on the common interest of the users.

The server generates at least one or more of content information for each user and content information for each terminal in consideration of the collected and classified user information, and extracts data, which is duplicated more than a specified number of times in the generated content information, to generate final content information.

The server generates the content information in consideration of environment information and the common interest of the users.

Each of the first user information and second user information includes content usage information of a user.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a content providing system according to an embodiment of the present disclosure;

FIG. 2 is a flowchart illustrating a content providing method according to an embodiment of the present disclosure;

FIGS. 3A to 3E are one example illustrating a procedure of providing contents according to an embodiment of the present disclosure; and

FIGS. 4A to 4F are another example illustrating a procedure of providing contents according to an embodiment of the present disclosure.

### DETAILED DESCRIPTION

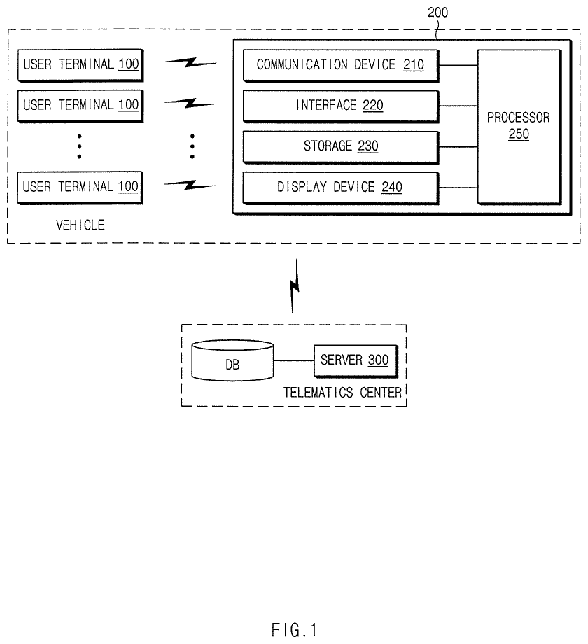

FIG. 1 is a block diagram illustrating a content providing system according to an embodiment of the present disclosure.

As illustrated in FIG. 1, the content providing system includes at least one or more user terminals 100, a vehicle terminal 200, and a server 300.

The user terminal 100 may be a hardware device, which is located in a vehicle and in which wireless and/or wired communication is possible, and may be implemented with a portable device such as a smartphone, a tablet, a Personal Digital Assistant (PDA), a Portable Multimedia Player (PMP), and/or a notebook computer.

Although not illustrated in FIG. 1, such the user terminal 100 includes a communication module, a user input module, an output module, a processor, and a memory.

The communication module of the user terminal 100 may perform wireless communication and/or wired communication with the vehicle terminal 200. Herein, a wireless Internet technology such as Wireless LAN (WLAN) (Wi-Fi), Wireless broadband (Wibro) and/or World Interoperability for Microwave Access (Wimax), a short range communication technology such as Bluetooth, Near Field Communication (NFC), Radio Frequency Identification (RFID), infrared Data Association (IrDA), Ultra-Wideband (UWB), and/or ZigBee, and/or a wired cable communication technology such as Universal Serial Bus (USB), Universal Synchronous/Asynchronous Receiver Transmitter (USART), and/or Ethernet may be used as a wireless communication technology.

The memory of the user terminal 100 may store an application (software, a program), which is installed in a terminal, such as a telematics application (application software, app) for communicating with a vehicle, and/or a navigation app providing directions. The memory of the user terminal 100 may store user information. The user information includes terminal identification information (e.g., a device number, a MAC address, or the like), information about an app installed in a terminal, app usage information, that is, content usage information of a user, user identification information (e.g., an ID registered in telematics), the user's name, the user's age, the user's gender, and/or a subscription date.

The vehicle terminal 200 senses the connection of the at least one or more user terminals 100 and extracts user information from the connected user terminal 100. The vehicle terminal 200 collects and classifies the extracted information and information stored in the vehicle terminal 200 to transmit the collected and classified information to the server 300. The vehicle terminal 200 provides contents based on the result in which the server 300 analyzes the collected and classified information. Herein, the content refers to content obtained by digitizing music, travel destinations, broadcasting, restaurants, games, advertisements, movies, and the like by using information technology (IT).

The vehicle terminal 200 may be implemented with a multimedia H/U, an Audio Video Navigation (AVN), or the like and includes a communication device 210, an interface 220, storage 230, a display device 240, and a processor 250.

The communication device 210 is a hardware device and performs data communication with the user terminal 100 and/or the server 300. The communication device 210 performs communication with the user terminal 100 via at least one or more of wireless Internet, short range communication, and wired communication. In addition, the communication device 210 communicates with the server 300 by using the wireless Internet, the short range communication, and/or mobile communication. Code Division Multiple Access (CDMA), Global System for Mobile communication (GSM), Long Term Evolution (LTE), and/or LTE-Advanced (LTE-A) may be used as a mobile communication technology.

The interface 220 is a medium for connecting the user terminal 100 to the vehicle terminal 200. The interface 220 receives data from the user terminal 100 or allows data inside the vehicle terminal 200 to be transmitted to the user terminal 100. For example, the interface 220 may be implemented with a USB port, a wired/wireless data port, a memory card port, an audio Input/output (I/O) port, a video I/O port, and/or an earphone port.

The storage 230 is a hardware device and may store a program for the operation of the processor 250 and may temporarily store pieces of input/output data. The storage 230 may store user information (second user information) including identification information of the vehicle terminal 200 and content usage information (e.g., frequently-listened songs in a vehicle, a recent playlist, and/or recently used radio frequency). The storage 230 may temporarily store user information received through the communication device 210.

The storage 230 may be implemented with at least one or more storage media (recording media) among a flash memory, a hard disk, a Secure Digital (SD) card, a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, a removable disc, web storage, and the like.

The display device 240 outputs information (data) generated depending on the operation of the processor 250. The display device 240 may include one or more display means such as a liquid crystal display (LCD), a thin film transistor-liquid crystal display (TFT LCD), an organic light-emitting diode (OLED) display, a flexible display, a 3D display, a transparent display, a head-up display (HUD), a touch screen, and a cluster.

Such the display device 240 may include a sound output module such as a speaker capable of outputting audio data. For example, the display device 240 may display the playlist and/or an item being played and may output an audio signal played through a speaker.

The processor 250 controls the overall operation of the vehicle terminal 200. The processor 250 may include at least one of an Application Specific Integrated Circuit (ASIC), a Digital Signal Processor (DSP), a Programmable Logic Devices (PLD), Field Programmable Gate Arrays (FPGAs), a Central Processing Unit (CPU), micro-controllers, and microprocessors.

The processor 250 senses the connection of the at least one or more user terminals 100 through the communication device 210 and/or the interface 220. For example, the processor 250 scans the user terminal 100, which is placed within a communication radius and in which Bluetooth communication is possible through the communication device 210 and exchanges paring information for paring with user terminal 100. Alternatively, the processor 250 senses the user terminal 100 connected to the interface 220 through a wired cable and transmits and/or receives information for communication with the corresponding user terminal 100, to and/or from the user terminal 100.

The processor 250 receives user information from the connected user terminal 100. The user terminal 100 transmits user information stored in a memory, to the vehicle terminal 200 when the connection to the vehicle terminal 200 is successful. The vehicle terminal 200 receives user information (first user information) transmitted from the user terminal 100 through the communication device 210 and/or the interface 220.

The processor 250 collects and classifies the received first user information and user information (second user information) stored in the storage 230. The processor 250 collects and classifies information for each user and/or for each device by using terminal identification information included in the first user information and the second user information. The processor 250 may store the collected and classified user information in the storage 230.

The processor 250 transmits the collected and classified user information to the server 300 of a telematics center. Afterwards, the processor 250 provides contents based on the result in which the server 300 analyzes the collected and classified user information.

The server 300 is disposed in the telematics center and stores and manages information (e.g., user information, terminal (device) information, and the like) about a user subscribing a telematics service, in a database DB. The database DB stores and manages vehicle information including a vehicle type (e.g., a sedan, a sport utility vehicle (SUV), a passenger car, or the like), when to buy a vehicle, a vehicle state, and the like. Herein, the vehicle state includes the current location of a vehicle, vehicle applying options (e.g., a panorama sunroof, premium sound, or the like), the number of speakers, and a sound system.

The server 300 receives the collected and classified user information transmitted from the vehicle terminal 200. The server 300 analyzes the collected and classified user information based on the environment information (context information) stored in the database DB to determine the common interest of users. Herein, the environment information may include weather, a place, the number of recommendations, and/or a search rank. The environment information may include content usage information for each user terminal and/or for each vehicle terminal stored in the DB. The server 300 generates content information based on the common interest of the users.

In other words, the server 300 may generate content information for each information, content information for each user, and/or content information for each terminal based on the received information. The server 300 selects content information, which is duplicated in the pieces of generated content information, to generate the final content information.

The server 300 transmits the content information generated as the analysis result, to the vehicle terminal 200. The vehicle terminal 200 may provide the content optimized for the common interest of the users, by using content information received from the server 300.

The server 300 may generate content information (analysis DB) by using a music content provider DB, an open search platform DB, a car dealer DB, and the like, which are connected over a communication network, in addition to cumulative data DB.

For example, the server 300 generates a frequently-listened music list for each age, by using age information included in the user information. Furthermore, the server 300 generates a frequently-listened music list (content information) for each gender by using gender information included in the user information.

The server 300 inquires the purchase customer base for each vehicle type and the preference specification in the vehicle manufacturer DB and generates content information in consideration of the inquired information. For example, the server 300 searches for music in a beat-fast and light atmosphere to generate a music list when it is inquired that the customer base purchasing the type of a vehicle, which is the same as a vehicle that a user is boarding, prefers a dynamic and sporty vehicle.

The server 300 generates a music list, to which a user frequently listens depending on weather, by using the DB included therein. The server 300 generates a music list by using terminal information about the user terminal 100 and the vehicle terminal 200. The server 300 generates a frequently-listened music list of users by sorting frequently-listened music depending on the number of times that a user listens to music, or generates a user's favorite music list by sorting the user's favorite music depending on the criteria of the recently favorite songs. The server 300 may analyze the frequently-listened music list and the favorite music list, may additionally search for music matched with the user's preference, and may generate a list.

The server 300 generates a final music list by collecting (extracting) data, which is duplicated more than the predetermined number of times in the generated music lists. In other words, the server 300 collects music, which is duplicated in a music list generated based on the user information, a music list generated based on the vehicle information, a music list generated by using information in the server 300, and a music list generated based on the terminal information, to generate the final music list.

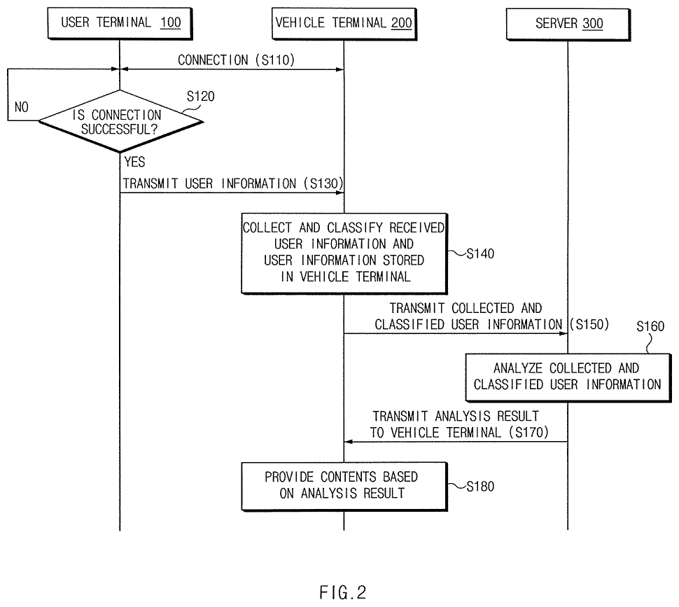

FIG. 2 is a flowchart illustrating a content providing method, according to an embodiment of the present disclosure.

Referring to FIG. 2, in operation S110, the vehicle terminal 200 recognizes (senses) the connection to the at least one or more user terminals 100. The processor 250 of the vehicle terminal 200 broadcasts an inquiry signal for the purpose of recognizing the user terminal 100 placed in a communication radius through the communication device 210 and makes a connection to each other when receiving an inquiry response signal transmitted from the user terminal 100. Alternatively, the vehicle terminal 200 sets the connection for communication with each other when the user terminal 100 is connected to the interface 220 via a wired cable.

In operation S120, the user terminal 100 may determine whether the connection to the vehicle terminal 200 is successful. The user terminal 100 may repeatedly attempt to connect to the vehicle terminal 200 until the connection to the vehicle terminal 200 is completed.

In operation S130, the user terminal 100 transmits user information to the vehicle terminal 200 via the connected communication line, when the connection to the vehicle terminal 200 is successful. Herein, the user information includes terminal identification information (e.g., a device number, a MAC address, or the like), information about an app installed in a terminal, application usage information, user identification information (e.g., ID registered in telematics), a user's name, the user's age, the user's gender, and/or a subscription date.

In operation S140, the vehicle terminal 200 receives user information transmitted from the user terminal 100 and collects and classifies the received user information (first user information) and user information (second user information) stored in the vehicle terminal 200. The vehicle terminal 200 receives the first user information through the communication device 210 and/or the interface 220. The vehicle terminal 200 collects and classifies the first user information and the second user information for each terminal and/or for each user based on user terminal identification information and vehicle terminal identification information included in the received first user information and the second user information. The vehicle terminal 200 may store the collected and classified user information in the storage 230.

In operation S150, the vehicle terminal 200 transmits the collected and classified user information to the server 300 of a telematics center. The vehicle terminal 200 transmits the collected and classified user information to the server 300 through the communication device 210.

In operation S160, the server 300 analyzes the collected and classified user information based on environment information stored in the database DB. The server 300 analyzes the collected and classified user information based on environment information stored in the DB, and then determines (grasps) the common interest of users. The server 300 generates content information based on the determined common interest of users. In other words, the server 300 determines pieces of data, which are duplicated, in pieces of content information generated for each item of user information as the common interest of users, extracts the corresponding pieces of data, and generates the final content information.

In operation S170, the server 300 transmits the analysis result to the vehicle terminal 200. The server 300 transmits the content information generated as the analysis result, to the vehicle terminal 200.

In operation S180, the vehicle terminal 200 provides contents based on the received analysis result. In other words, the vehicle terminal 200 outputs content information received from the server 300, to the display device 240.

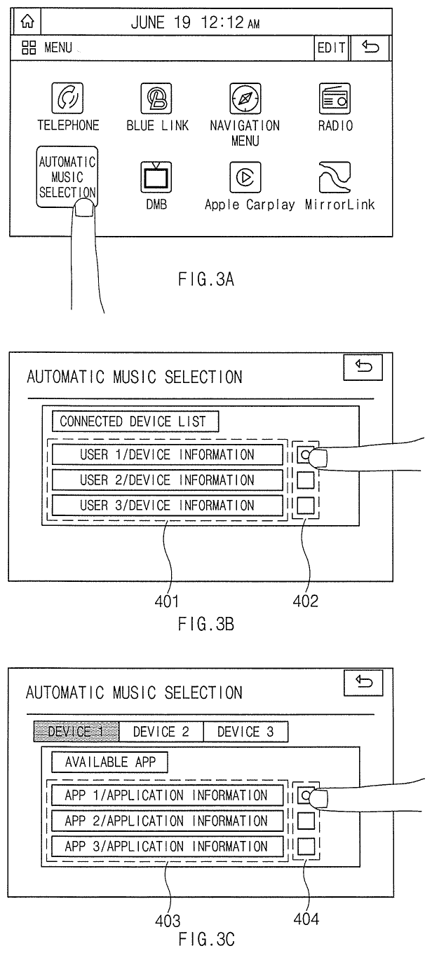

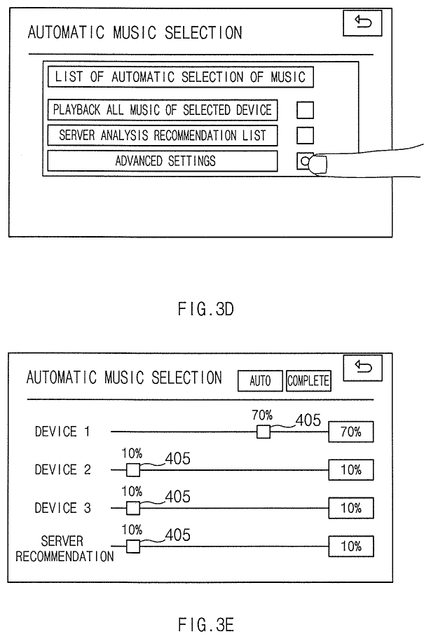

FIGS. 3A to 3E are one example illustrating a procedure of providing contents, according to an embodiment of the present disclosure. An embodiment is exemplified as a music list is provided as content information.

The vehicle terminal 200 senses the corresponding user terminal 100 to operate in conjunction with the vehicle terminal 200, when a user connects the user terminal 100 to the vehicle terminal 200. At this time, it is possible to connect the vehicle terminal 200 to the two or more user terminals 100. That is, the vehicle terminal 200 supports a multi connection.

Afterwards, the vehicle terminal 200 displays the full menu screen as illustrated in FIG. 3A. As illustrated in FIG. 3B, the vehicle terminal 200 displays a sub menu of an “automatic music selection” menu in response to a user input, when the user selects the “automatic music selection” among the menu items of the full menu screen. As illustrated in FIG. 3B, a list (device list) 401 of user terminals connected to the vehicle terminal 200 and a selection box 402 corresponding to each item in a list are displayed on a sub menu screen. The user selects (touches) the selection box 402 corresponding to items of at least one or more user terminal in the user terminal list 401. The vehicle terminal 200 may provide the generated playlist based on the selected terminal information.

Referring to FIG. 3C, the vehicle terminal 200 displays an application list 403 capable of being used for each user terminal, in response to the user's selection. The vehicle terminal 200 selects at least one or more applications depending on whether a selection box 404 is checked.

The vehicle terminal 200 determines the user terminal 100 and an application, which extract user information, in response to a user input. The vehicle terminal 200 extracts the first user information from the determined the user terminal 100 and the determined application. For example, the user selects the user terminal 100, in which a music-related app is installed, and selects the music-related app selected by the corresponding user terminal 100, when the user desires to extract the user information associated with music content. The vehicle terminal 200 extracts the first user information from the selected user terminal 100 and the music-related app in the corresponding user terminal 100. Herein, the first user information may include the user's name, the user's age, the user's gender, a subscription date, frequently-listened songs, favorite songs, a recent playlist, and/or the saved playlist.

The vehicle terminal 200 collects and classifies the first user information extracted from the user terminal 100 and the second user information stored in the storage 230 of the vehicle terminal 200 to transmit the collected and classified first user information and the collected and classified second user information to the server 300. Herein, the second user information may include a frequently-listened music list in a vehicle, the saved playlist, a recently used radio frequency, and/or preset storage radio frequency.

The vehicle terminal 200 identifies user information for each user and/or user information for each device, by using terminal identification information included in the first user information. The vehicle terminal 200 separately assigns the identification information of the vehicle terminal 200, when storing information in the storage 230.

The server 300 receives the collected and classified user information transmitted from the vehicle terminal 200 and analyzes the collected and classified user information based on the environment information stored in the DB. At this time, the server 300 may also analyze the collected and classified user information by using information stored in a music content provider DB, an open search platform DB, a car manufacturer/dealer DB, and the like.

The server 300 analyzes the collected and classified user information to grasp the common interest of users and generates content information based on the grasped common interest of the users. For example, the server 300 generates the recommendation playlist (content information), to which the common interest of the users is reflected, based on the environment information such as a current weather, a vehicle location, and the like.

The server 300 transmits the recommendation playlist to the vehicle terminal 200. As illustrated in FIG. 3D, the vehicle terminal 200 displays a selection item corresponding to the received recommendation playlist, in the display device 240. At this time, the vehicle terminal 200 may also display the selection item such as full music playback of the selected user terminal 100, advanced settings, and the like.

The vehicle terminal 200 adds the recommendation playlist provided from the server 300 to the final playlist to play music, when “server analysis recommendation list” is selected from the automatic selection list illustrated in FIG. 3D.

The vehicle terminal 200 may perform list weight processing by setting the priority (server recommendation weight) (%) through adjustment of a scroll bar 405 as shown in FIG. 3E, when the “advanced settings” are selected from the automatic selection list shown in FIG. 3D. For example, referring to FIG. 3E, the vehicle terminal 200 sets the 70% playlist of the final playlist to music that the server 300 extracts and recommends from device 1, and sets the 10% playlist of the final playlist to the music that the server 300 extracts and recommends from device 2 and device 3.

Furthermore, the vehicle terminal 200 may freely adjust the music order in the final playlist in response to a user input. The vehicle terminal 200 may adjust the music playback order in the final playlist depending on a user's command such as terminal order, random or shuffle.

The server 300 stores the analysis contents in the DB; the server 300 may quickly and accurately process information by using the information stored in the DB, when the same user and terminal are connected later. Moreover, the server 300 may perform the same data analysis by using the information stored in the DB of the server 300, even when the user boards another vehicle.

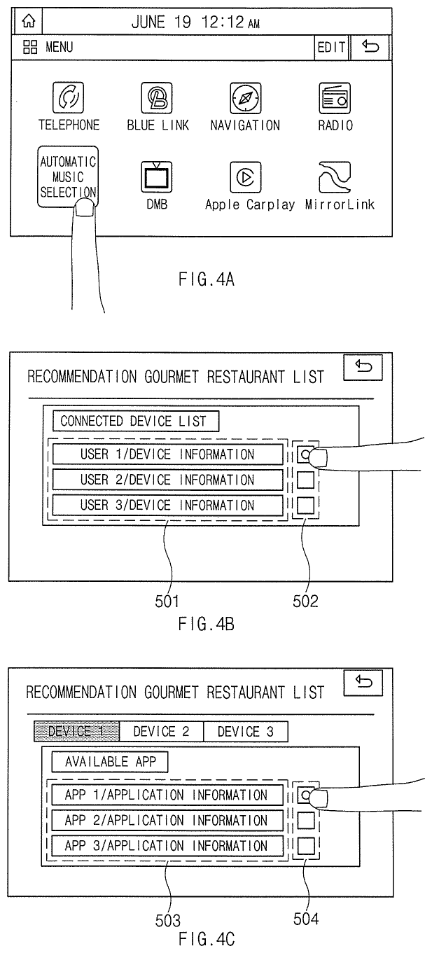

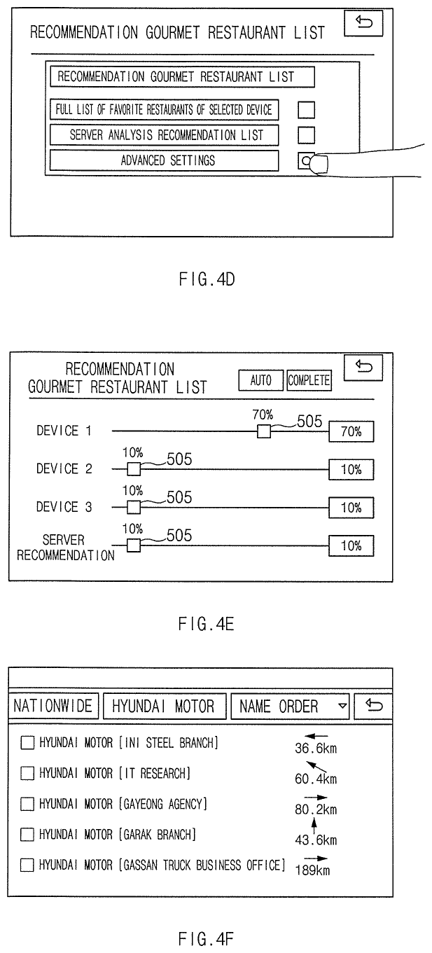

FIGS. 4A to 4F are another example illustrating a procedure of providing contents, according to an embodiment of the present disclosure.

The vehicle terminal 200 makes a connection to the at least one or more user terminals 100. As illustrated in FIG. 4A, the vehicle terminal 200 displays a full menu screen. As illustrated in FIG. 4B, the vehicle terminal 200 displays the sub menu of a “recommendation gourmet restaurant list” menu in response to a user input, when a user selects the “recommendation gourmet restaurant list” menu on the full menu screen. As illustrated in FIG. 4B, the vehicle terminal 200 displays a list (device list) 501 of user terminal connected to the vehicle terminal 200 and a selection box 502 corresponding to each item in a list.

The vehicle terminal 200 selects the user terminal 100 depending on the check of the selection box 502, and as illustrated in FIG. 4C, displays an application list 503 available for each user terminal. The vehicle terminal 200 selects at least one or more applications depending on whether a selection box 504 is checked.

The vehicle terminal 200 extracts user information from the user terminal and the application according to the user's selection. The user information includes favorite restaurants in a frequently-used map application, favorite restaurants in a social network service (SNS), restaurant coupons that the user has, restaurant discount card information, or the like.

The vehicle terminal 200 collects and classifies the user information extracted from the user terminal 100 and the user information stored in the vehicle terminal 200 to transmit the collected and classified user information to the server 300. The user information stored in the vehicle terminal 200 includes a frequently-visited restaurant list at a periphery of the destination of a navigation terminal and/or a favorite restaurant list.

The server 300 analyzes the collected and classified user information received from the vehicle terminal 200. At this time, the server 300 analyzes the user information by using information of nearby recommendation restaurants stored in the DB, recent trend foods, top-ranking restaurants in various multimedia, or the like.

The server 300 grasps the common interest of users through the analysis of the user information and generates a recommendation gourmet restaurant list, to which the grasped common interest is reflected, to transmit the recommendation gourmet restaurant list to the vehicle terminal 200. As illustrated in FIG. 4D, the vehicle terminal 200 displays available recommendation gourmet restaurant lists, when receiving the recommendation gourmet restaurant list from the server 300.

In other words, the server 300 generates content information (analysis DB) in consideration of the user information provided from the vehicle terminal 200. At this time, the server 300 may generate content information by using a food information providing content provider DB and an open search platform DB, or the like in addition to the DB included therein.

The server 300 generates a list of restaurants, which users frequently visit for each age, and a list of restaurants, which users frequently visit for each gender, by using age information and gender information, which are included in the user information. In addition, the server 300 generates a list of restaurants that a user frequently visits for each time at which the user searches.

Furthermore, the server 300 generates a list of frequently-visited restaurants by using information about the destination of a navigation device obtained from the vehicle terminal 200, collects a list of restaurants, which are located within a specific radius from the current location of a vehicle, from a favorite list, and extracts data, which is duplicated, to generates a restaurant list.

Moreover, the server 300 may generate a list of frequently-visited restaurants using the search history of a frequently-used map application, by using terminal information, may generate a favorite restaurant list based on information such as the SNS application's posts and followings, may generate a restaurant list by using information about a coupon owned by a user for each restaurant, and may generate a restaurant list by using information about a discount card available for each restaurant.

The server 300 generates restaurants, which are duplicated more than the specific number of times, in the generated restaurant lists as the final gourmet restaurant list to provide the vehicle terminal 200. At this time, the server 300 may provide the vehicle terminal 200 with a gourmet restaurant list for each terminal generated based on the terminal information.

As illustrated in FIG. 4E, the vehicle terminal 200 adjusts a scroll bar 505 to displays a screen capable of setting the priority (server recommendation weight) (%), when the user selects “advanced settings” among available recommendation gourmet restaurant lists.

The vehicle terminal 200 arranges the final gourmet restaurant lists in consideration of information about a name, a distance, and/or a discount to display the arranged result as illustrated in FIG. 4F, when the setting of the priority is completed. Further, as illustrated in FIG. 4F, the vehicle terminal 200 supports additional search using a keyword in the displayed final gourmet restaurant list.

The vehicle terminal 200 arranges the final gourmet restaurant list depending on the name, distance and discount rate, when displaying the final gourmet restaurant list. Furthermore, the vehicle terminal 200 may support keyword search in the displayed final gourmet restaurant list.

The present disclosure may analyze the common interest of users by using information in multiple devices connected to a vehicle and then may provide the users with the optimized content based on the analyzed common interest of the users.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system for providing contents comprising:
at least one or more user terminals having first user information;
a vehicle terminal configured to receive the first user information from the at least one or more user terminals and configured to collect and classify the first user information and pre-stored second user information; and
a server configured to analyze the first and second user information collected and classified by the vehicle terminal,
wherein the vehicle terminal provides contents based on an analyzed result from the server.

2. The system of claim 1, wherein the vehicle terminal includes:
a communication device configured to perform wireless communication with at least one or more of the at least one or more user terminals and the server;
an interface configured to support wired communication with the at least one or more user terminals; and
a processor configured to sense connections of the at least one or more user terminals through at least one or more of the communication device and the interface.

3. The system of claim 2, wherein the communication device performs wireless communication by using at least one or more of wireless Internet, short range communication, and mobile communication.

4. The system of claim 2, wherein the interface includes a port for connecting the at least one or more user terminals to the vehicle terminal via a wired cable.

5. The system of claim 2, wherein the at least one or more user terminals transmit the first and second user information to the vehicle terminal through at least one or more of the communication device and the interface.

6. The system of claim 2, wherein the processor collects and classifies the first user information and the second user information based on terminal identification information of the at least one or more user terminals and the vehicle terminal.

7. The system of claim 6, wherein the server analyzes the first and second user information collected and classified by the vehicle terminal to grasp a common interest of users, and generates content information based on the grasped common interest of the users.

8. The system of claim 7, wherein the server generates content information for each user in consideration of the first and second user information collected and classified by the vehicle terminal and extracts data, which is duplicated more than a specified number of times in the generated content information for each user, to generate final content information.

9. The system of claim 7, wherein the server generates content information for each terminal in consideration of the first and second user information collected and classified by the vehicle terminal and extracts data, which is duplicated more than a specified number of times in the generated content information for each terminal, to generate final content information.

10. The system of claim 9, wherein the vehicle terminal receives the final content information from the server to display the final content information.

11. The system of claim 1, wherein each of the first user information and second user information includes content usage information of a user.

12. A vehicle terminal comprising:
a communication device configured to perform wireless communication with at least one or more user terminals and a server;
a processor configured to receive first user information from the at least one or more user terminals; and
a storage configured to store second user information,
wherein the processor is further configured to:
collect and classify the first user information and the second user information to transmit the collected and classified first and second user information to the server; and
provide contents based on a result in which the server analyzes the collected and classified first and second user information.

13. A method for providing contents, the method comprising steps of:
making, by a vehicle terminal, a connection to at least one or more user terminals;
receiving, by the vehicle terminal, first user information from the connected at least one or more user terminals;
collecting and classifying, by the vehicle terminal, the received first user information and pre-stored second user information to transmit the collected and classified first and second user information to a server;
analyzing, by the server, the first and second user information collected and classified by the vehicle terminal to transmit an analyzed result to the vehicle terminal; and
providing, by the vehicle terminal, contents based on the analyzed result.

14. The method of claim 13, wherein, in the step of making the connection, the at least one or more user terminals are connected to the vehicle terminal over wireless communication or wired communication.

15. The method of claim 13, wherein, in the step of receiving the first user information, the connected at least one or more user terminals transmit the first user information including identification information of the at least one or more user terminals, to the vehicle terminal.

16. The method of claim 13, wherein, in the step of collecting and classifying the received first user information and the pre-stored second user information to transmit the collected and classified first and second user information to the server, the vehicle terminal collects and classifies the first user information and the second user information stored in the vehicle terminal, based on identification information of the at least one or more user terminals and the vehicle terminal.

17. The method of claim 16, wherein, in the step of transmitting the analyzed result to the vehicle terminal, the server analyzes the collected and classified user information to grasp a common interest of users, and generates content information based on the common interest of the users.

18. The method of claim 17, wherein the server generates at least one or more of content information for each user and content information for each terminal in consideration of the collected and classified user information, and extracts data, which is duplicated more than a specified number of times in the generated content information, to generate final content information.

19. The method of claim 17, wherein the server generates the content information in consideration of environment information and the common interest of the users.

20. The method of claim 13, wherein each of the first user information and second user information includes content usage information of a user.
